(19) United States
(12) Patent Application Publication
(10) Pub. No.: US 2016/0163236 A1
(43) Pub. Date: Jun. 9, 2016

(54) Day tracking system for food storage container lids

(71) Applicants: Elaine Rose Sperl, Little Falls, MN (US); Gary Alan Sperl, Little Falls, MN (US)

(72) Inventors: Elaine Rose Sperl, Little Falls, MN (US); Gary Alan Sperl, Little Falls, MN (US)

(21) Appl. No.: 14/565,405

(22) Filed: Dec. 9, 2014

(51) Int. Cl. G09F 3/10

(52) U.S. Cl. CPC G09F 3/10

(57) ABSTRACT

A series of seven expandable/collapsible buttons, each engraved with a different abbreviated week day Monday through Sunday. These buttons would either be molded on a tab as part of a food storage container lid, or as a separate hinged tab with an adhesive back. These molded buttons would be placed on the lid's side, front, or lip. A consumer would place food into the container, expand the correlating day's button and refrigerate. Knowing the storage day would help determine food freshness for future use. Only seven days are used because food science instructs most foods should not be kept beyond 3-4 days refrigerated. Side button placement on the container allows the expanded button to be clearly visible to the consumer when containers are stacked. The buttons and the tabs may take on a variety of shapes as are necessary to fit the container that utilizes this system.

### CROSS REFERENCE TO RELATED APPLICATIONS

Provisional patent application 61/963,619

Confirmation number 5772

### STATEMENT REGARDING FEDERALLY SPONSORED RESEARCH OR DEVELOPMENT

Non-applicable

### REFERENCE TO SEQUENCE LISTING, A TABLE, OR COMPUTER PROGRAM LISTING COMPACT DISC APPENDIX

Non-applicable

### BACKGROUND OF THE INVENTION

Our invention of the day tracking system for food storage container lids is related to the food storage field of endeavor.

Food science tells us food placed inside food storage containers, and then placed in the refrigerator should not be kept beyond 3-4 days because bacteria contained in the food is not killed by refrigeration but only has its growth slowed due to refrigeration. If refrigerated for longer than 4 days, food spoilage and food poisoning are considered real possibilities.

Once the food is placed in the refrigerator it becomes difficult to remember what day it was stored thus making it difficult to properly determine if it is safe to eat. In a commercial kitchen, this is also a problem due to the strict 72 hour food storage limit the law requires.

We began looking for a food storage container system to accurately track the day food was refrigerated. We found only one brand that had a designated space to write the date on top of the lid with a special pen. We felt this was too cumbersome and many people would not utilize it. The designated space was also on the top of the lid, so when the containers are stacked the date is not visible at a quick glance.

We began to design a day tracking system for food storage containers that was quick and easy to use, that didn't require extra parts, that was easy to read the day stored in the refrigerator at a quick glance when the food storage containers are stacked, and that would be able to reused many times and easily cleaned.

### BRIEF SUMMARY OF THE INVENTION

Our invention of the day tracker system for food storage containers is a simple and effective way for consumers to mark the day they put their food in the container and placed it in the refrigerator. The day tracker system is made up of a series of seven buttons as part of a plastic tab attached to the side, edge or lip of the food storage container. Each of the seven buttons is expandable/collapsible and have molded on them an abbreviation for a day of the week Monday through Sunday.

Food science tells us food placed in refrigeration should not be kept longer than 3-4 days to still be safe to eat. Consequently, the consumer can easily push out the button for the day of the week the food was stored and tell quickly on subsequent days how long it has been in the refrigerator. They no longer will have to guess if it is safe to eat.

Our day tracker system lids have the buttons placed on the side of the food storage container so the day can easily be seen when the containers are stacked in the refrigerator. This system does not require the consumer to get out tape and a pen to mark the day and can be reused time and time again. It is easily washed and stored as it is part of the lid.

Commercially, our day tracker system would have a time saving effect for staff because staff could easily mark the day food was stored to comply with the strict 72 hour food storage limit required by law.

A consumer using our day tracker system would save money by not throwing away food because they were unsure if it was safe to eat and would benefit the environment with much less food being wasted.

### BRIEF DESCRIPTION OF THE SEVERAL VIEWS OF THE DRAWING

FIG. 1=Example of a square food storage container lid with a living hinge including day tracker system buttons

FIG. 2=Close up of the hinged tab from FIG. 1 FIG. 3=Side view (front view) of the closed lid with day tracker system buttons FIG. 4=Example of a round food storage container lid with a living hinge including day tracker system buttons

FIG. 5=Side view of expandable/collapsible button FIG. 6A=Day tracker system buttons in a two row configuration on a plastic tab with adhesive backing

FIG. 6B=Day tracker system buttons in a one row configuration on a plastic tab with adhesive backing

### DETAILED DESCRIPTION OF THE INVENTION

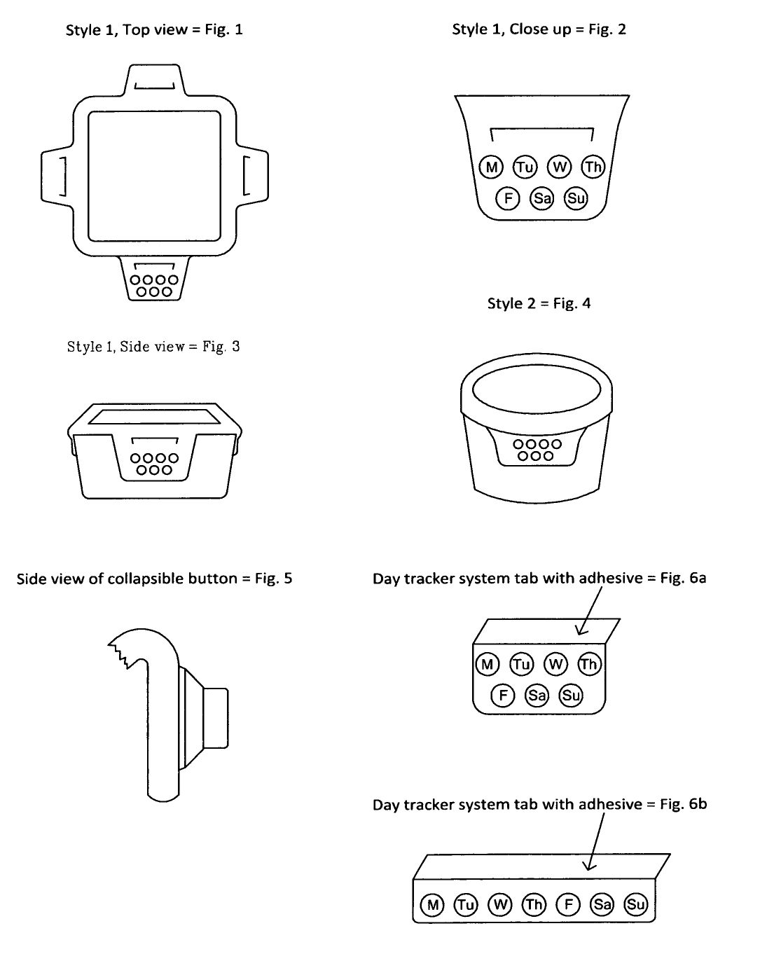

Our day tracker system for food storage container lids features a series of seven buttons each of which is engraved with an abbreviation for a day of the week (M,Tu,W,Th,F,Sa,Su), see FIGS. 6A and 6B. These buttons are molded into a living hinged piece of plastic that is either a part of the lid (FIG. 1) with the point of attachment being the lip or side of the lid or as a separate tab (FIG. 6A or 6B) that can be affixed to the lid lip or side with an adhesive backing. Either method of adding the buttons to the lid results in the buttons being easily viewed from the front of a food storage container as it would sit on a refrigerator shelf. (FIG. 3)

The buttons will be made of an expandable/collapsible plastic material that can expand out or towards the user and will also collapse back or flat onto itself when not being called into use. Placing a food storage container with the day tracking system in the refrigerator on a Monday would involve the user to expand or push from behind the button with an M on it thus delineating it in appearance from the other six buttons which remain flat. Other food container lids could have buttons with different days expanded and the user could tell at a quick glance when any container was placed in the refrigerator.

We have seen no other invention like ours. The main features of our invention are the easy viewing of the buttons from a front view, the simplicity of use and the expandable/collapsible nature of our buttons.

We came up with our idea independent from any other invention. Elaine is a home economics major and came up with idea from a desire to know what food was placed In the refrigerator at a quick glance so we could cut down on our wasted food as much as possible. Upon doing our patent research, we discovered only 1 patent remotely close to what we were envisioning. That patent is U.S. Pat. No. 6,938,768,B2 also listed as CA2426250A1 or CA2426250C which involves a complex set of indent buttons with days of the week and day of the month located on the top of a food container lid. Our invention differs from this patent in a number of ways. Our day tracker system buttons are visible from the front of the lid while theirs are on the top of the lid. Our system is simple to use tracking only the day food is placed into refrigeration while theirs involves a more complex method of tracking days and months and identifying expiration date. We have seven buttons that are expandable/collapsible and their system has many buttons that are more bubble in nature. We feel the simplicity and ease of use of our system is critical to a product actually being used by consumers leading to a marked reduction in food being wasted due to lack of knowledge as to how long this food has been in the refrigerator. We are hopeful this product will be a source of reducing family food waste and subsequently environmental waste.

1. We claim that our day tracking system is made up of a series of seven buttons as part of a plastic tab that will be attached to the side, edge or lip of a food storage container.

2. The day tracking system of claim 1 will contain buttons that are expandable/collapsible and have molded on them an abbreviation for a day of the week Monday through Sunday.

3. These aforementioned buttons of claim 1 may be arranged seven in one row or seven buttons split into two rows as part of the plastic tab to fit the food storage container lid style most effectively.

4. These aforementioned tab and buttons of claim 1 shall be made out of a type of plastic that is safe for food storage and will withstand the temperatures associated with refrigeration as well as being dishwasher safe.

5. These aforementioned tab buttons of claim 1 shall be made of a collapsible plastic that extends out (forward) when expanded for use, stays in place when extended, and folds in flat on itself when not expanded for use.

6. This aforementioned day tracking system of claim 1 shall be molded as part of a food storage container lid or manufactured as a separate entity which could then attach via an adhesive type strip to the side of any food storage container lid.

7. The purpose of the aforementioned day tracking system of claim 1 is to help a consumer track the day their food was stored in the food storage container and placed in the refrigerator ensuring they can properly evaluate in the future this food's safety for use.
